(19) United States
(12) Patent Application Publication
(10) Pub. No.: US 2024/0265769 A1
(43) Pub. Date: Aug. 8, 2024

(54) Method and System for Executing a Live Game

(71) Applicant: Evolution Malta Limited, St. Julians (MT)

(72) Inventors: Nik Robinson, North Bondi (AU); Kristela Campos, Riga (LV)

(21) Appl. No.: 18/106,345

(22) Filed: Feb. 6, 2023

(51) Int. Cl. G07F 17/32; G07F 17/34

(52) U.S. Cl. CPC G07F 17/3225; G07F 17/3204; G07F 17/3258; G07F 17/3272; G07F 17/3288; G07F 17/34

(57) ABSTRACT

A computer-implemented method and a system for executing a live game, such as a casino slot game. The method includes transmitting a video stream of the live game to remote electronic devices, receiving data indicative of a request to participate in a game round of the game, receiving data indicative of a placed bet for spins in the game round, and calculating a winning sum for the spins based on the outcomes of the spins and the placed bets. For each game round that is preceded by a foregoing game round, the method includes starting the game round prior to the foregoing game round reaching a resolution state.

### TECHNICAL FIELD

The disclosed technology relates to computer-implemented methods and systems for executing a live game. In particular, but not exclusively, the disclosed technology relates to computer-implemented methods and systems for executing a live casino slot game that is streamed to a plurality of remote electronic devices.

### BACKGROUND

A popular type of casino games is slot games. In conventional slot machines, a player places bets and hits a spin button of the slot machine, causing reels of the slot machine having symbols to spin away and stop after a certain period of time. The player wins if the player hits a winning combination of symbols, and the player loses otherwise. Some slot machines offer unique features such as multipliers which may e.g., multiply winnings by a value or a pattern. Slot games are popular as they are simple, entertaining, do not require much user input, and they provide a likelihood of winning money.

Over the past years, online slot games have developed a lot and become very popular, as they offer players to play the slot games online at any desired location. In such online slot games, the player communicates with a gaming system which operates a casino game, and the player is presented with a casino-like animation at their device. The online slot games use an algorithm generated by a computer to randomize the results of a spin known as a random number generator (RNG).

With a further attempt to provide a more immersive and exciting gaming atmosphere, live online games have been developed. In existing live casino games, a live dealer or operator operates a casino game at a studio. A video of the studio, the dealer, and the operated game are communicated to a remote electronic device of the player. When the remote player wishes to join a game, they communicate with a server, operated by the game-provider, which creates a connection between the player and the operator in the studio. Thereby remote players are able to join the game that is operated in the studio, emulating the atmosphere of a live casino, online.

For live online slot games, the player makes a bet via an input device of their electronic device, which is communicated to the game server and authentication process is executed by a wallet application or the like. Between rounds of the game, i.e., during a so-called “bets open” period, the players are allowed to place bets. It is desirable to reduce the duration of the “bets open” period in order to provide a high pace and increase excitement for the players. However, due to the inherent delay originating at least in part from latency issues of the live video stream and the authentication process, the game-provider generally has to provide a sufficiently long period to ensure that the players' bets are properly processed and accepted so to avoid rejection of a bet, which would cause a player to miss a round, and therefore impair the game experience.

Therefore, there is a need to provide improved methods and systems of executing live online games to address the shortcomings of the conventional live online games. In addition, it is also desired to provide an improved method and system of executing live online slot games with new and unique functionalities.

### SUMMARY

The herein disclosed technology seeks to mitigate, alleviate or eliminate one or more of the above-identified deficiencies and disadvantages in the prior art to address various problems relating to prolonged waiting times between game rounds and player rejections caused by latency issues.

It is another object of some embodiments disclosed herein to provide an improved method and system for executing the live game in an efficient and user-friendly manner. It is yet another object of some embodiments disclosed herein to provide an improved method and system for executing the live game by providing an improved live game in terms of functionality.

Various aspects and embodiments of the disclosed invention are defined below and in the accompanying independent and dependent claims.

A first aspect of the disclosed technology comprises a computer-implemented method for executing a live game is provided. The method comprises, by a processor of a game server transmitting a video stream of the live game to a plurality of remote electronic devices. Each remote electronic device comprising a display apparatus and a user input device. The live game is a casino slot game comprising a plurality of consecutive game rounds. Each game round starts with a bets open period within which bets placed by any user of any remote electronic device are accepted by the game server for that game round, followed by an active game period that ends in a resolution state, wherein bets placed, during the active game period, by any user of any remote electronic device, are rejected for that game round. Each game round comprises a plurality of spins of the casino slot game during the active game period. The method further comprises receiving, from one or more of the plurality of remote electronic devices, data indicative of a request to participate in a game round of the casino slot game. The method further comprises receiving, from the one or more of the plurality of remote electronic devices, data indicative of a placed bet for each spin of the plurality of spins in the game round. The method further comprises calculating, for each remote electronic device of the one or more of the plurality of remote electronic devices, a winning sum for each spin based on an outcome of each spin and the placed bet for each spin of the plurality of spins. The method further comprises, by the processor of the game server, for each game round that is preceded by a foregoing game round starting the game round prior to the foregoing game round reaching the resolution state.

In some embodiments, the computer-implemented further comprises, by the processor of the game server, for each spin of the plurality of spins, generating a symbol having an attribute corresponding to a multiplier value, a free-spin accumulator, a bonus value, a blank, or a wild card symbol. The method further comprises, by the processor of the game server, in response to the generated symbol having the attribute corresponding to the multiplier value, combining the multiplier value with any multiplier values generated for any preceding spin within the same game round. The step of calculating, for each remote electronic device of the one or more of the plurality of remote electronic devices, the winning sum is further based on the combined multiplier value.

Another aspect of the disclosed technology comprises a computer program product. The computer program product comprises instructions which, when the program is executed by a computer, causes the computer to carry out the method according to any one of the embodiments disclosed herein. With this aspect of the disclosed technology, similar advantages and preferred features are present as in the other aspects.

Another aspect of the disclosed technology comprises a (non-transitory) computer-readable storage medium. The computer-readable storage medium comprises instructions which, when executed by a computer, causes the computer to carry out the method according to the first aspect of the invention. With this aspect of the disclosed technology, similar advantages and preferred features are present as in the other aspects.

The term “non-transitory,” as used herein, is intended to describe a computer-readable storage medium (or “memory”) excluding propagating electromagnetic signals but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link. Thus, the term “non-transitory”, as used herein, is a limitation of the medium itself (i.e., tangible, not a signal) as opposed to a limitation on data storage persistency (e.g., RAM vs. ROM).

Another aspect of the disclosed technology comprises a system for executing a live game is provided. The system comprises a game server comprising a processor configured to transmit a video stream of the live game to a plurality of remote electronic devices. Each remote electronic device comprises a display apparatus and a user input device. The live game is a casino slot game comprising a plurality of consecutive game rounds. Each game round starts with a bets open period within which bets placed by any user of any remote electronic device are accepted by the game server for that game round, followed by an active game period that ends in a resolution state. Bets placed, during the active game period, by any user of any remote electronic device, are rejected for that game round. Each game round comprises a plurality of spins of the casino slot game during the active game period. The processor is further configured to receive, from one or more of the plurality of remote electronic devices, data indicative of a request to participate in a game round of the casino slot game. The processor is further configured to receive, from the one or more of the plurality of remote electronic devices, data indicative of a placed bet for each spin of the plurality of spins in the game round. The processor is further configured to calculate, for each remote electronic device of the one or more of the plurality of remote electronic devices, a winning sum for each spin based on an outcome of each spin and the placed bet for each spin of the plurality of spins. The processor is further configured to, for each game round that is preceded by a foregoing game round start the game round prior to the foregoing game round reaching the resolution state. With this aspect of the disclosed technology, similar advantages and preferred features are present as in the other aspects.

The disclosed aspects and preferred embodiments may be suitably combined with each other in any manner apparent to anyone of ordinary skill in the art, such that one or more features or embodiments disclosed in relation to one aspect may also be considered to be disclosed in relation to another aspect or embodiment of another aspect.

An advantage of some embodiments is the waiting time or dead time between consecutive game rounds is reduced, thereby increasing the number of games that can be played over time without increasing the risk of player rejections, which consequently may provide for an improved user experience.

Further embodiments are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof.

These and other features and advantages of the disclosed technology will in the following be further clarified with reference to the embodiments described hereinafter.

### BRIEF DESCRIPTION OF THE DRAWINGS

The above aspects, features and advantages of the disclosed technology, will be more fully appreciated by reference to the following illustrative and non-limiting detailed description of example embodiments of the present disclosure, when taken in conjunction with the accompanying drawings, in which:

FIG. 1 is a schematic flowchart representation of a method for executing a live game in accordance with some embodiments.

FIG. 2 is a schematic flow diagram representation of a method for executing a live casino slot game in accordance with some embodiments.

FIG. 3 is a schematic block diagram representation of a system for executing a live casino slot game in accordance with some embodiments.

FIG. 4 shows schematic illustrations of a live casino slot game in accordance with some embodiments.

### DETAILED DESCRIPTION

The present disclosure will now be described in detail with reference to the accompanying drawings, in which some example embodiments of the disclosed technology are shown. The disclosed technology may, however, be embodied in other forms and should not be construed as limited to the disclosed example embodiments. The disclosed example embodiments are provided to fully convey the scope of the disclosed technology to the skilled person. Those skilled in the art will appreciate that the steps, services and functions explained herein may be implemented using individual hardware circuitry, using software functioning in conjunction with a programmed microprocessor or general-purpose computer, using one or more Application Specific Integrated Circuits (ASICs), using one or more Field Programmable Gate Arrays (FPGA) and/or using one or more Digital Signal Processors (DSPs).

In the following description of exemplary embodiments, the same reference numerals denote the same or similar components. In some of the illustrated embodiments the same or similar components have not all been provided with reference numerals so to avoid unnecessary cluttering of the drawings. However, such obvious considerations are readily understood and appreciated by the skilled person in the art and should not be construed as limiting to the or in any other way have a negative impact on the present disclosure.

It will also be appreciated that when the present disclosure is described in terms of a method, it may also be embodied in apparatus comprising one or more processors, one or more memories coupled to the one or more processors, where computer code is loaded to implement the method. For example, the one or more memories may store one or more computer programs that causes the apparatus to perform the steps, services and functions disclosed herein when executed by the one or more processors in some embodiments.

It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may refer to more than one unit in some contexts, and the like. Furthermore, the words “comprising”, “including”, “containing” do not exclude other elements or steps. It should be emphasized that the term “comprises/comprising” when used in this specification is taken to specify the presence of stated features, integers, steps, or components. It does not preclude the presence or addition of one or more other features, integers, steps, components, or groups thereof. The term “and/or” is to be interpreted as meaning “both” as well and each as an alternative.

It will also be understood that, although the term first, second, etc. may be used herein to describe various elements or features, these elements should not be limited by these terms. These terms are only used to distinguish one element from another. For example, a first signal could be termed a second signal, and, similarly, a second signal could be termed a first signal, without departing from the scope of the embodiments. The first signal and the second signal are both signals, but they are not the same signal.

In conventional live online casino slot games, a new a new game round starts after a current game round has reached a resolution state. For traditional live online casino slot games, a game round is generally a spin of the reels of the slot game. For the purpose of the present disclosure, a live online game is to be understood as a multiplayer game where a plurality of remote players are connected to a live studio and take part in the same game and therefore are presented with the same results. For live online casino slot games, this consequently means that if one player wins, all of the participating players win.

Moreover, for conventional live online casino slot games, for each game round of a plurality of consecutive game rounds, players need to wait during the bets open period of the game round until the active game period of the respective game round begins. Typically, for each game round of a plurality of consecutive game rounds, the players need to wait for at least 10 see until the active game period of respective game round begins. Thus, in contrast to the traditional single player slot games (online and offline), there is an inherent delay between game rounds for live online casino slot games, which tend to impair the overall gaming experience for the players and also reduce the number of game rounds that can be played per time unit.

As mentioned in the foregoing, the delay is at least part caused by the fact that the game provider needs to offer a sufficiently long “bets open” period prior to launching a new game for players to be able to participate as there is unavoidably some latency caused by the live video stream being broadcasted to various players, some of which may be connected to the game server via slow network connections. Generally, a provider of a live online casino slot game needs to deliver a “bets open” period of at least 10 seconds in order to ensure that all players are given a sufficiently long period of time to place and authenticate their bets and to compensate for any potential latency issues. To simply reduce the “bets open” window is generally not feasible as the risk of player rejections increases (i.e., a placed bet is rejected as the game server was not able to receive and process it in due time prior to closing the “bets open” window and starting the game), which drastically impairs the user experience.

Accordingly, an advantage of some embodiments herein is that the delay or waiting time between consecutive game rounds is reduced for live online casino slot games while still providing a sufficiently long “bets open” period to compensate for potential latency issues and reduce the risk of player rejections.

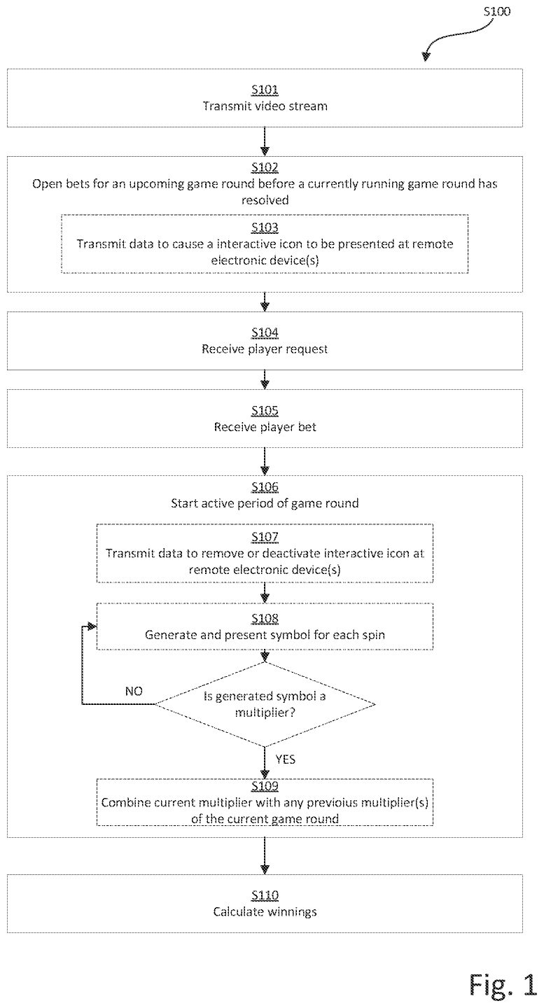

FIG. 1 is a schematic flowchart representation of a method S100 for executing a live game in accordance with some embodiments. In particular, the method S100 is suitable for providing a live online casino game, such as a live online casino slot game, to a plurality of remote electronic devices. The method S100 is preferably a computer-implemented method S100, performed by a computing device (e.g., a game server). The computing device (e.g., game server) may for example comprise one or more processors and one or more memories coupled to the one or more processors, wherein the one or more memories store one or more programs that cause the computing device to perform the steps, services and functions of the method S100 disclosed herein when executed by the one or more processors.

The method S100 comprises, by a processor of a game server, transmitting S101 a (live) video stream of the live game to a plurality of remote electronic devices, where each remote electronic device comprises a display apparatus and a user input device. The video stream may for example be a live video feed of a studio where an operator operates a live casino game that is streamed to a plurality of remote electronic devices over a communication network (i.e., over the internet). The remote electronic devices may for example be user devices such as smart phones, tablets, personal computers, laptops, or similar. The term “remote” is to be construed as that the electronic devices are remote from a game server associated with the studio where the live game takes place.

Moreover, the live game is a casino slot game comprising a plurality of consecutive game rounds. Here, each game round starts with a bets open period within which bets placed by any user of any remote electronic device are accepted by the game server for that game round, followed by an active game period that ends in a resolution state. Bets that are placed during the active game period, by any user of any remote electronic device of the plurality of remote electronic device, are rejected for that game round. In other words, the bets open period defines a betting window within which bets or wagers can be submitted by the players (i.e., users of the remote electronic devices). The active period accordingly starts with a “bets closed” state, which defines a point in time, after which bets or wagers no longer are accepted by the game server for the remainder of the game round.

Further, each game round comprises a plurality of spins of the casino slot game during the active game period. Thus, in contrast to traditional casino slot games where a game round is generally defined by a single spin of the reels, each game round of the transmitted S101 video stream of the live online casino slot game has a plurality of spins of the reels of the live online casino slot game during the active game period. In some embodiments, each game round of the live online casino slot game comprises 3 spins during the active game period, 5 spins of the active game period, 7 spins of the active game period, or 10 spins of the active game period. Moreover, each game round of the live online casino slot game may comprise any number of spins in the range of 2-20 spins. It should be noted that the number of spins mentioned are excluding any “free-spins” that can be awarded during any game round.

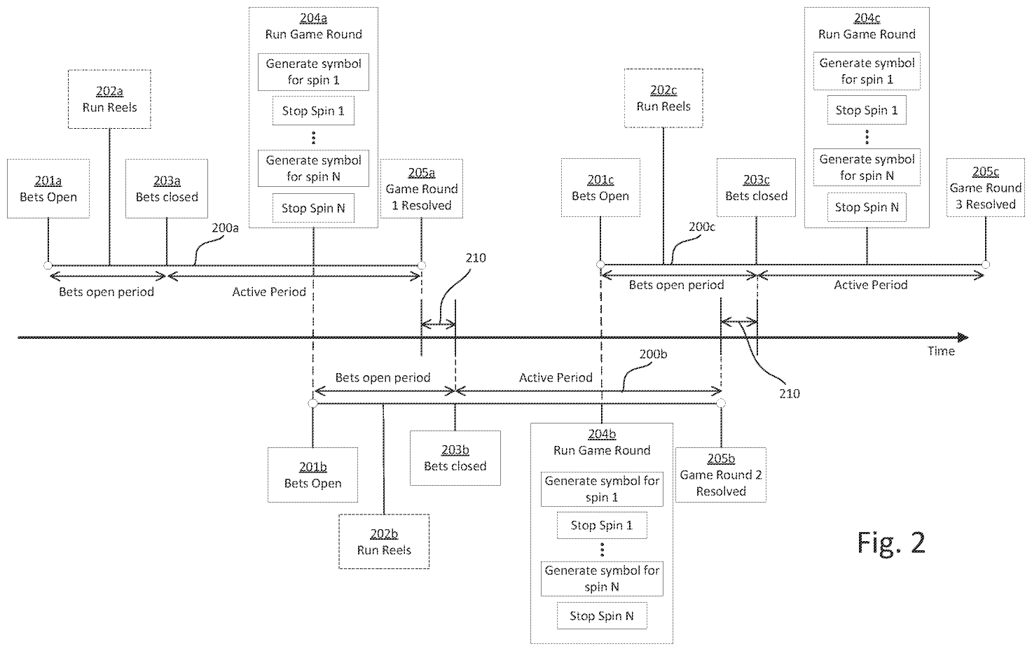

The method S100 further comprises, for each game round of the plurality of consecutive game rounds, by the processor of the game server, starting S102 the game round prior to a foregoing game round reaching the resolution state. In other words, the method S100 comprises, by the processor of the game server, opening S102 bets (i.e., launching the bets open period) for an upcoming game round before a currently running game round as reached the resolution state. In some embodiments, the upcoming game round is started 1-30 seconds prior to the foregoing game round reaching the resolution state. Thereby, in contrast to conventional live online casino slot games, who employ a “linear” process for executing each game round, the herein disclosed method S100 provides an “overlap” between two consecutive game rounds so that the time between two consecutive game rounds can be kept low, so to avoid unnecessary waiting time for currently active users between game rounds, while at the same time providing adequate time for new players that want to join an upcoming game round. This overlapping game flow is further elaborated upon in reference to FIG. 2 below.

Moreover, in some embodiments, the starting S102 of the game round prior to the foregoing game round reaching the resolution comprises transmitting S103 to the plurality of remote electronic devices, a signal causing each of the plurality of remote electronic devices to display, at the display apparatus, an interactive icon indicative of the bets open period for the started game round.

Still further, the method S100 comprises receiving S104, from one or more of the plurality of remote electronic devices, data indicative of a request to participate in a game round of the live online casino slot game. In some embodiments, the data indicative of a request to participate in a game round of the live online casino slot game is transmitted from a remote electronic device in response to a user of the remote electronic device interacting with the interactive icon indicative of the bets open period.

Further, the method S100 comprises receiving S105 from the one or more of the plurality of remote electronic devices, data indicative of a placed bet for each spin of the plurality of spins in the game round. It should be noted that the reception S104 of data indicative of the request to participate in a game round may occur concurrently with the reception S105 of data indicative of a placed bet. In other words, if a bet is placed by a user of a remote electronic device, then it may be used as an indication or confirmation that the user requests to participate in the upcoming game round.

In some embodiments, the method S100 further comprises, following the receiving S105 of bets and a closing of the bets open period for a current or upcoming game round, starting S106 the active period of the current or upcoming game round, for the one or more remote electronic devices of the plurality of remote electronic devices whose bets have been confirmed by the game server. The method S100 may further comprise, transmitting S107, to the plurality of remote electronic devices (that are in communicative connection with the game server), data causing each of the plurality of remote electronic devices to remove or deactivate the displayed interactive icon indicative of the bets open period for the started game round.

The method S100 further comprises, by the processor of the game server, calculating S110, for each remote electronic device of the one or more of the plurality of remote electronic devices (i.e. the participating users), a winning sum for each spin based on an outcome of each spin and the placed bet for each spin of the plurality of spins.

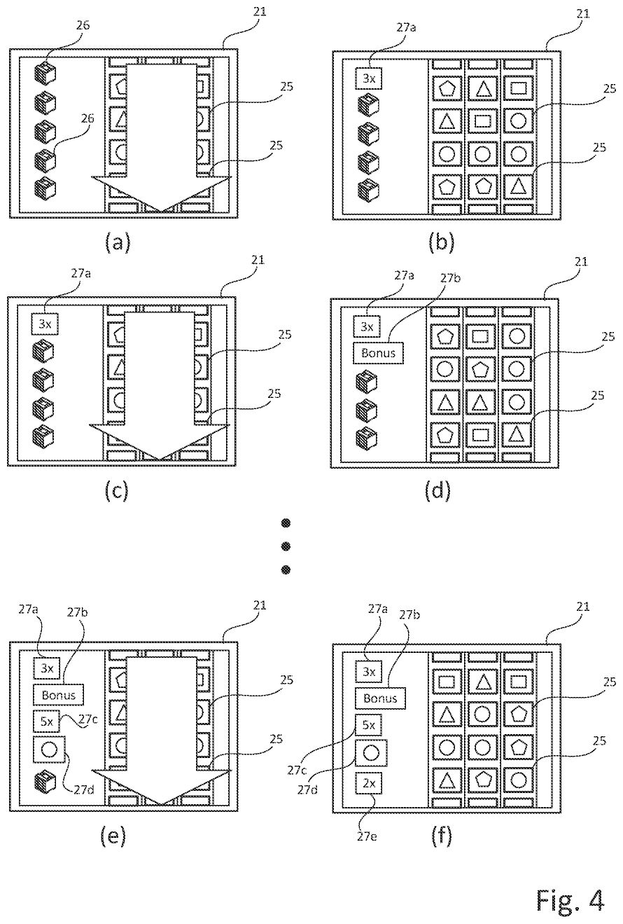

Further, in some embodiments, the method S100 comprises, by the processor of the game server, for each spin of the plurality of spins, generating S108 a symbol having an attribute corresponding to a multiplier value, a free-spin accumulator, a bonus value, a blank, or a wild card symbol. The method S100 may further comprise, by the processor of the game server, in response to the generated S108 symbol having the attribute corresponding to the multiplier value, combining S109 the multiplier value with any multiplier values generated for any preceding spin within the same game round. The combination S109 of multiplier values may be in the form of an aggregation (i.e. a sum), a multiplication (i.e. a product), or any other suitable combination. For example, the combined S109 multiplier value may be formed based on the current spin's multiplier value+any preceding multiplier value+1, or the combined value may be formed based on the current spin's multiplier value+2 times any preceding multiplier value, and so forth. Moreover, the step of calculating S110, for each remote electronic device of the one or more of the plurality of remote electronic devices, the winning sum, may accordingly be further based on the combined multiplier value. Further details with regards to the generation S108 of symbols and combination S109 of multiplier values are given with reference to FIG. 4 below.

Executable instructions for performing these functions are, optionally, included in a non-transitory computer-readable storage medium or other computer program product configured for execution by one or more processors.

FIG. 2 is a schematic flow diagram representation of a method for executing a live online casino game in accordance with some embodiments. In particular, FIG. 2 serves to illustrate the game flow for three consecutive game rounds 200a-200c, and how they overlap in time so that one game round is launched 201a-201c prior to the resolution state 205a-205c of a directly preceding game round.

Each game round comprises a “bets open” period and an “active period” as indicated by the double-headed arrows in FIG. 2. The bets open period starts with a bets open state 201a-201c, after which bets can be placed by the players for that game round 200a-200c and ends with a bets closed state 203a-203c defining the end of the bets open period. In some embodiments, the processor of the game server may be configured to run the reels 202a-202c during the bets open period to indicate that the active period is about to start and that the bets open period is ending.

During the active period of a game round 200a-200c, the live online casino slot game is executed 204a. As mentioned, each game round comprises a plurality of spins of the reels of the slot game, here indicated as N spins, where N may be any suitable positive integer larger than 2. Furthermore, in some embodiments, a symbol having an attribute corresponding to a multiplier value, a free-spin accumulator, a bonus value, a blank, or a wild card symbol is generated in conjunction with each respective spin. Accordingly, the running 204a of a game round may comprise generating and presenting a first symbol for a first spin of the reels, stopping the reels, displaying an outcome of the spin and indicate if the players have won, spinning the reels for the second spin, generating and presenting a second symbol for the second spin of the reels, stopping the reels, displaying an outcome of the spin and indicate if the players have won, and so forth until N spins have been executed. Once all of the N spins have been executed, the game round is resolved 205a-205c. In some embodiments, the players may be awarded a number of free-spins or bonus spins at the end of the round (e.g., based on an outcome of the symbols), which accordingly are executed after the reels have been stopped after the Nth spin, and the game resolution 205a-205c is postponed until the free-spins or bonus spins have been executed.

As indicated by the double-headed arrow 210 in FIG. 2, the waiting time between the active periods, which in a conventional setting, would be the entire bets open period, is reduced to only a portion of the bets open period. Moreover, the waiting time between the active periods has been reduced without compromising the length of the bets open period and therefore without increasing the risk of players not being able to participate in an upcoming game round due to a too short bets open time window in combination with latency issues. Thus, by means of the herein disclosed technology, it is possible to provide a high-pace and immersive live online casino game experience while adhering to any requirements regarding the length of the bets open time period for providing an adequate time for players to select, submit and authenticate their bets. For example, the bets open period may be 10 seconds in total, while the waiting time 210 may be reduced to 2-4 seconds.

The bets open period for any game round may for example start when the system estimates that the preceding game round is 5 seconds from reaching the resolution state 205a-205c, 7 seconds from reaching the resolution state 205a-205c 10 seconds from reaching the resolution state 205a-205c, 15 seconds from reaching the resolution state 205a-205c, or 20 seconds from reaching the resolution state 205a-205c. Since the length of each spin can be predefined or pre-programmed, it is straightforward to estimate the time left until resolution during each game round 200a-200c. The total length of each game round may vary between 1 minute and 5 minutes (depending on dynamic events occurring during each game round, such as e.g., free-spins or bonus spins).

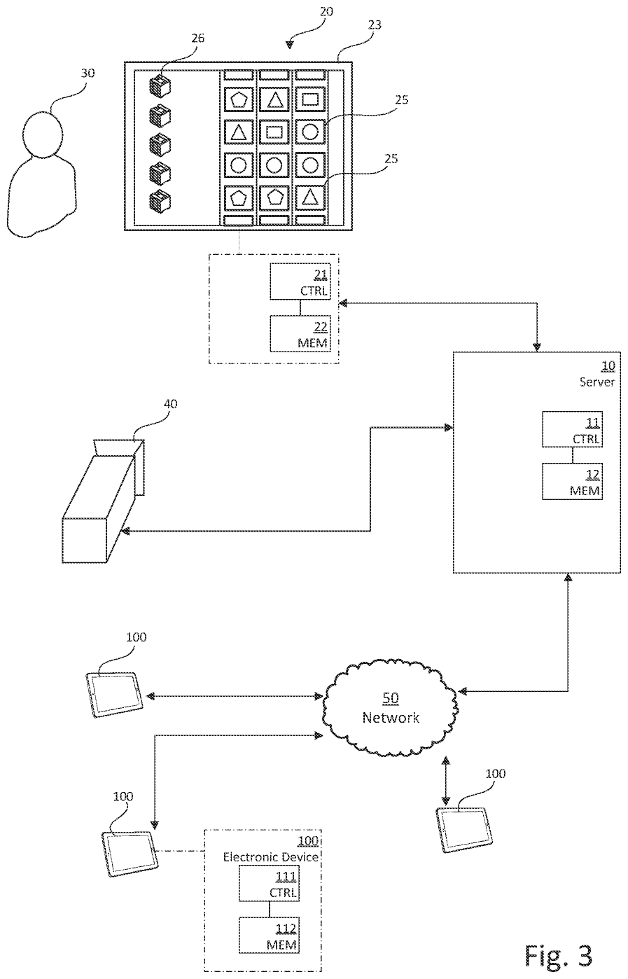

FIG. 3 is a schematic block diagram representation of a system for executing a live game. In particular, the system is suitable for providing a live online casino game, such as a live online casino slot game, to a plurality of remote electronic devices. The system comprises a game server 10 having one or more processors 11 (may also be referred to as control circuitry) and one or more data storage devices 12 or memory devices 12. The memory 12 of the game server 10 can include one or more (non-transitory) computer-readable storage mediums, for storing computer-executable instructions, which, when executed by one or more computer processors 11, for example, can cause the game server to perform the techniques described herein. The memory 12 optionally includes high-speed random-access memory, such as DRAM, SRAM, DDR RAM, or other random access solid-state memory devices; and optionally includes non-volatile memory, such as one or more magnetic disk storage devices, optical disk storage devices, flash memory devices, or other non-volatile solid-state storage devices. Furthermore, the game server 10 may have one or more communication interfaces (not shown) for communicating with peripheral entities or remote entities.

The one or more processors 11 are configured to transmit a video stream of the live game to a plurality of remote electronic devices 100, here in the form of tablet computers, where each remote electronic device 100 comprises a display apparatus and a user input device (e.g., a touch screen). Moreover, each remote electronic device 100 comprises suitable hardware (e.g., processors 111, memories 112, etc.) and software for executing various software applications as known in the art. The game server 10 and the remote electronic devices 50 are communicatively connected via a communication network 50.

The video stream may for example be a live video feed of a studio where an operator 30 operates a live casino game 20 that is streamed to a plurality of remote electronic devices 100 over a communication network (i.e., over the internet) 50. The remote electronic devices 100 may for example be user devices such as smart phones, tablets, personal computers, laptops, or similar. The term “remote” is to be construed as that the electronic devices are remote from a game server 10 associated with the studio where the live game takes place. The casino slot game may for example be a virtual slot-machine game 20 displayed on a studio display apparatus 23 (e.g., an LED screen), and the video stream is accordingly captured by a camera 40 arranged to monitor the studio display apparatus 23.

Accordingly, in some embodiments, the system comprises a studio display apparatus 23 presenting a live casino game (such as a live casino slots game) 20, a camera 40 recording a video stream of the display apparatus 23, and a server 10 obtaining the video stream and transmitting the video stream to a plurality of remote electronic devices 100. Each of the remote electronic devices 100 may comprise one or more processors 111, at least one memory 112, a communication interface, a display, and at least one user input device. The processor 111 of the remote electronic device is arranged to operate instructions sets stored in the memory 112 for displaying the video stream and detecting user input events from the at least one user input device, and further arranged to execute various functions and applications for participating in the live casino game.

The live-casino slot game 20 is schematically illustrated in FIG. 3, where three animated reels carrying various game symbols 25 and bonus symbols 26, here in the form of animated crates, are provided on the studio display apparatus 23. The live-casino slot game is played by providing a spinning animation of the three reels, and optionally, an animation of opening the animated crates to reveal a symbol having an attribute corresponding to a multiplier value, a free-spin accumulator, a bonus value, a blank, or a wild card symbol. Accordingly, in association which each spin of the plurality of spins (5 in total in the depicted embodiment) in a game round, one of the crates is “opened” so to reveal the symbol. Winnings are generally awarded based on the outcome of the spinning reels.

The camera 40 may be arranged to record a larger area then just the studio display apparatus 23, for instance a surrounding studio with people 30 and other props being part of the video recorded. The camera 40 can for instance be a dedicated video camera, a DSLR camera with video capabilities, a mirrorless camera with video capabilities, or any other type of image recording device capable of recording video sequences for instance using CMOS or CCD chips. The studio display apparatus 23 may be controlled by a display control device comprising one or more processors 21 and one or more memories 22 for generating images or controlling features of the studio display apparatus 23 for generating images on the remote display. The display control device may operate independently or optionally be controlled by or incorporated into the game server 10.

As before, the live game is a live casino slot game comprising a plurality of consecutive game rounds. Here, each game round starts with a bets open period within which bets placed by any user of any remote electronic device are accepted by the game server 10 for that game round, followed by an active game period that ends in a resolution state. Bets that are placed during the active game period, by any user of any remote electronic device 100 of the plurality of remote electronic device, are rejected for that game round. In other words, the bets open period defines a betting window within which bets or wagers can be submitted by the players (i.e., users of the remote electronic devices 100). The active period accordingly starts with a “bets closed” state, which defines a point in time, after which bets or wagers no longer are accepted by the game server for the remainder of the game round. Each game round comprises a plurality of spins of the casino slot game during the active game period.

Further, the processor 11 of the game server 10 is configured to, for each game round of the plurality of consecutive game rounds, start the game round prior to a foregoing game round reaching the resolution state. In other words, the processor 11 is configured to open bets (i.e., launching the bets open period) for an upcoming game round before a currently running game round as reached the resolution state.

In some embodiments, the processor 11 is configured to transmit to the plurality of remote electronic devices 100, data causing each of the plurality of remote electronic devices 100 to display, at the display apparatus, an interactive icon indicative of the bets open period for the started game round.

Further, the processor 11 is configured to receive, from one or more of the plurality of remote electronic devices 100, data indicative of a request to participate in a game round of the casino slot game. In some embodiments, the data indicative of a request to participate in a game round of the live online casino slot game is transmitted from a remote electronic device in response to a user of the remote electronic device interacting with the interactive icon indicative of the bets open period.

The processor 11 is further configured to receive, from the one or more of the plurality of remote electronic devices 100, data indicative of a placed bet for each spin of the plurality of spins in the game round. As before, it should be noted that the reception of data indicative of the request to participate in a game round may occur concurrently with the reception of data indicative of a placed bet. In other words, if a bet is placed by a user of a remote electronic device 100, then it may be used as an indication or confirmation that the user requests to participate in the upcoming game round.

In some embodiments, the processor 11 is further configured to, following the reception (and confirmation) of bets and a closing of the bets open period for a current or upcoming game round, start the active period of the current or upcoming game round, for the one or more remote electronic devices 100 of the plurality of remote electronic devices 100 whose bets have been received (and confirmed) by the game server 10. The processor 11 may be further configured to transmit, to the plurality of remote electronic devices 100 (that are in communicative connection with the game server), data causing each of the plurality of remote electronic devices 100 to remove or deactivate the displayed interactive icon indicative of the bets open period for the started game round.

The processor 11 is further configured to calculate, for each remote electronic device 100 of the one or more of the plurality of remote electronic devices 100 (i.e. the participating players), a winning sum for each spin based on an outcome of each spin and the placed bet for each spin of the plurality of spins.

Furthermore, in some embodiments, the processor 11 is configured to, for each spin of the plurality of spins, generate a symbol having an attribute corresponding to a multiplier value, a free-spin accumulator, a bonus value, a blank, or a wild card symbol. The processor 11 may be further configured to, in response to the generated symbol having the attribute corresponding to the multiplier value, combining the multiplier value with any multiplier values generated for any preceding spin within the same game round. The combination of multiplier values may be in the form of an aggregation (i.e., a sum), a multiplication (i.e., a product), or any other suitable combination.

FIG. 4 is a schematic illustration showing a series of consecutive spins (a)-(f) in a game round in accordance with some embodiments. In more detail, FIG. 4 serves to elucidate the attributes of the multiplier aggregation mentioned in the foregoing.

Thus, when the active period of a game round starts, an animation where the reels, and their associated game symbols, are spinning, is presented on the studio display apparatus 21. Then, a first symbol is generated, e.g., via an animation of the first crate 26 being opened, where the generated symbol 27a has an attribute corresponding to a 3× multiplier value, and the spinning reel animation is stopped. Thus, any winnings awarded for the first spin are multiplied 3 times.

In step (c), the second spin starts by another animation where the reels, and their associated game symbols, are spinning, is presented on the studio display apparatus 21. Then, a second symbol is generated, e.g., via an animation of the second crate 26 being opened, where the generated symbol has an attribute corresponding to a bonus symbol. The bonus symbol may for example be associated with a bonus game that is awarded given the fulfilment of one or more bonus game criteria (e.g., collection of a set number of bonus symbols 27b).

This process continues until all of the plurality of spins (5 in the depicted embodiment) have been completed for the game round. In step (f) the outcome after the last spin of the game round is illustrated. Here, spin number 3 was associated with a symbol 27c having an attribute corresponding to a 5× multiplier. Therefore, in accordance with some embodiments, the calculation of the winning sum for spin 3 is based on a combined multiplier value. For example, any winnings awarded for the third spin were multiplied 8 times (3+5) or 15 times (3×5). Similarly, the calculation of the winning sum for the last spin (spin 5) is based on another combined multiplier value. For example, any winnings awarded for the fifth spin were multiplied 10 times (3+5+2) or 30 times (3×5×2). The symbols 27d and 27e can be used for similar purposes as the symbols 27a, 27b, and 27c.

Moreover, in some embodiments, the combined multiplier value may be carried over to each subsequent spin. In other words, in the depicted example of FIG. 4, any winnings awarded for the first spin were multiplied 3×, any winnings awarded for the second spin were multiplied 3×, any winnings awarded for the third spin were multiplied 8× (3+5), any winnings awarded for the fourth spin were multiplied 8×, and any winnings awarded for the fifth spin were multiplied 10× (3+5+2). As mentioned, the combination of multiplier values may be defined based on a combined sum (i.e., aggregation/addition), a combined product (i.e., multiplication), or any other suitable methodology.

The present invention has been presented above with reference to specific embodiments. However, other embodiments than the above described are possible and within the scope of the invention. Different method steps than those described above, performing the method by hardware or software, may be provided within the scope of the invention. Thus, according to some embodiments, there is provided a non-transitory computer-readable storage medium storing one or more programs configured to be executed by one or more processors of a vehicle control system, the one or more programs comprising instructions for performing the method according to any one of the above-discussed embodiments. Alternatively, according to some embodiments, a cloud computing system can be configured to perform any of the methods presented herein. The cloud computing system may comprise distributed cloud computing resources that jointly perform the methods presented herein under control of one or more computer program products.

Generally speaking, a computer-accessible medium may include any tangible or non-transitory storage media or memory media such as electronic, magnetic, or optical media—e.g., disk or CD/DVD-ROM coupled to computer system via bus. The terms “tangible” and “non-transitory,” as used herein, are intended to describe a computer-readable storage medium (or “memory”) excluding propagating electromagnetic signals but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

The processor(s) 11, 21, 111 (associated with the server 10, remote electronic device 100, display control device 20) may be or include any number of hardware components for conducting data or signal processing or for executing computer code stored in memory 12, 22, 112. The memory 12, 22, 122 may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to some embodiments the memory is communicably connected to the processor (e.g., via a circuit or any other wired, wireless, or network connection) and includes computer code for executing one or more processes described herein.

It should be noted that any reference signs do not limit the scope of the claims, that the invention may be at least in part implemented by means of both hardware and software, and that several “means” or “units” may be represented by the same item of hardware.

Although the figures may show a specific order of method steps, the order of the steps may differ from what is depicted. In addition, two or more steps may be performed concurrently or with partial concurrence. For example, the steps of receiving data indicative of a request to participate and receiving data indicative of a placed bet may be interchanged based on a specific realization. Such variation will depend on the software and hardware systems chosen and on designer choice. All such variations are within the scope of the invention. Likewise, software implementations could be accomplished with standard programming techniques with rule-based logic and other logic to accomplish the various transmission steps, reception steps, calculation steps and execution steps. The above mentioned and described embodiments are only given as examples and should not be limiting to the present invention. Other solutions, uses, objectives, and functions within the scope of the invention as claimed in the below described patent claims should be apparent for the person skilled in the art.

1. A computer-implemented method, comprising:
transmitting a video stream of a live game to a plurality of remote electronic devices, wherein:
the live game is a casino slot game comprising a first game round and a second game round;
the first game round includes a bets open game period during which bets placed from any of the plurality of remote electronic devices are accepted, followed by an active game period that ends in a resolution state during which bets placed from any of the plurality of remote electronic devices are rejected; and
the first game round comprises a plurality of spins of the casino slot game that occur during the active game period;
receiving, from the plurality of remote electronic devices, data indicative of requests to participate in the first game round;
receiving, from the plurality of remote electronic devices, data indicative of placed bets for each of the plurality of spins in the first game round;
calculating, for each of the plurality of remote electronic devices, a winning sum for each of the plurality of spins in the first game round based on an outcome of each of the plurality of spins in the first game round and the placed bets for each of the plurality of spins in the first game round; and
starting the second game round of the casino slot game prior to reaching the resolution state of the first game round.

2. The method of claim 1, wherein:
the casino slot game is a virtual slot machine game displayed on a studio display apparatus; and
transmitting the video stream of the live game to the plurality of remote electronic devices comprises transmitting a video stream captured by a camera arranged to monitor the studio display apparatus.

3. The method of claim 1, further comprising:
generating, for a first spin of the plurality of spins in the first game round, a first symbol corresponding to a first multiplier value;
generating, for a second spin of the plurality of spins in the first game round, a second symbol corresponding to a second multiplier value; and
calculating, for the second spin, the winning sum based on a combined multiplier generated using the first multiplier value and the second multiplier value.

4. The method of claim 1, wherein starting the second game round of the casino slot game prior to reaching the resolution state of the first game round comprises transmitting, to the plurality of remote electronic devices, data causing each of the plurality of remote electronic devices to display an interactive icon indicative of the second game round starting.

5. The method of claim 4, further comprising receiving, from the plurality of remote electronic devices, data indicative of requests to participate in the second game round based on interactions with the interactive icon.

6. The method of claim 1, further comprising, for each of the plurality of spins in the first game round, generating a symbol having an attribute corresponding to a multiplier value, a free-spin accumulator, a bonus value, a blank, or a wild card symbol.

7. The method of claim 1, wherein starting the second game round of the casino slot game prior to reaching the resolution state of the first game round comprises starting the second game round 1-30 seconds prior to reaching the resolution state of the first game round.

8. A system comprising:
a camera capturing a video stream of a live game displayed on a screen; and
a game server in communication with the camera and comprising at least one processor configured to:
receive the video stream of the live game from the camera;
transmit the video stream of the live game to a plurality of remote electronic devices, wherein:
the live game is a casino slot game comprising a first game round and a second game round;
the first game round includes a bets open game period during which bets placed from any of the plurality of remote electronic devices are accepted, followed by an active game period that ends in a resolution state during which bets placed from any of the plurality of remote electronic devices are rejected; and
the first game round comprises a plurality of spins of the casino slot game that occur during the active game period;
receive, from the plurality of remote electronic devices, data indicative of requests to participate in the first game round;
receive, from the plurality of remote electronic devices, data indicative of placed bets for each of the plurality of spins in the first game round;
calculate, for each of the plurality of remote electronic devices, a winning sum for each of the plurality of spins in the first game round based on an outcome of each of the plurality of spins in the first game round and the placed bets for each of the plurality of spins in the first game round; and
start the second game round of the casino slot game prior to reaching the resolution state of the first game round.

9. The system of claim 8, wherein the at least one processor of the game server is configured to, for each of the plurality of spins in the first game round, generate a symbol having an attribute corresponding to a multiplier value, a free-spin accumulator, a bonus value, a blank, or a wild card symbol.

10. The system of claim 8, wherein the at least one processor of the game server is configured to:
generate, for a first spin of the plurality of spins in the first game round, a first symbol corresponding to a first multiplier value;
generate, for a second spin of the plurality of spins in the first game round, a second symbol corresponding to a second multiplier value; and
calculate, for the second spin, the winning sum based on a combined multiplier generated using the first multiplier value and the second multiplier value.

11. The system of claim 8, wherein the at least one processor of the game server is configured to start the second game round of the casino slot game prior to reaching the resolution state of the first game round by transmitting, to the plurality of remote electronic devices, data causing each of the plurality of remote electronic devices to display an interactive icon indicative of the second game round starting.

12. The system of claim 11, wherein the at least one processor of the game server is configured to receive, from the plurality of remote electronic devices, data indicative of requests to participate in the second game round based on interactions with the interactive icon.

13. The system of claim 8, wherein the at least one processor of the game server is configured to start the second game round of the casino slot game 1-30 seconds prior to reaching the resolution state of the first game round.

14. A non-transitory computer-readable medium having instructions stored thereon that, when executed by at least one processor, cause the at least one processor to implement operations comprising:
transmitting a video stream of a live game to a plurality of remote electronic devices, wherein:
the live game is a casino slot game comprising a first game round and a second game round;
the first game round includes a bets open game period during which bets placed from any of the plurality of remote electronic devices are accepted, followed by an active game period that ends in a resolution state during which bets placed from any of the plurality of remote electronic devices are rejected; and
the first game round comprises a plurality of spins of the casino slot game that occur during the active game period;
receiving, from the plurality of remote electronic devices, data indicative of requests to participate in the first game round;
receiving, from the plurality of remote electronic devices, data indicative of placed bets for each of the plurality of spins in the first game round;
calculating, for each of the plurality of remote electronic devices, a winning sum for each of the plurality of spins in the first game round based on an outcome of each of the plurality of spins in the first game round and the placed bets for each of the plurality of spins in the first game round; and
starting the second game round of the casino slot game prior to reaching the resolution state of the first game round.

15. The computer-readable medium of claim 15, wherein:
the casino slot game is a virtual slot machine game displayed on a studio display apparatus; and
transmitting the video stream of the live game to the plurality of remote electronic devices comprises transmitting a video stream captured by a camera arranged to monitor the studio display apparatus.

16. The computer-readable medium of claim 15, the operations further comprising:
generating, for a first spin of the plurality of spins in the first game round, a first symbol corresponding to a first multiplier value;
generating, for a second spin of the plurality of spins in the first game round, a second symbol corresponding to a second multiplier value; and
calculating, for the second spin, the winning sum based on a combined multiplier generated using the first multiplier value and the second multiplier value.

17. The computer-readable medium of claim 15, wherein starting the second game round of the casino slot game prior to reaching the resolution state of the first game round comprises transmitting, to the plurality of remote electronic devices, data causing each of the plurality of remote electronic devices to display an interactive icon indicative of the second game round starting.

18. The computer-readable medium of claim 17, the operations further comprising receiving, from the plurality of remote electronic devices, data indicative of requests to participate in the second game round based on interactions with the interactive icon.

19. The computer-readable medium of claim 15, the operations further comprising, for each of the plurality of spins in the first game round, generating a symbol having an attribute corresponding to a multiplier value, a free-spin accumulator, a bonus value, a blank, or a wild card symbol.

20. The computer-readable medium of claim 15, wherein starting the second game round of the casino slot game prior to reaching the resolution state of the first game round comprises starting the second game round 1-30 seconds prior to reaching the resolution state of the first game round.
